(19) United States
(12) Patent Application Publication
(10) Pub. No.: US 2017/0353712 A1
(43) Pub. Date: Dec. 7, 2017

(54) PULSED GATED STRUCTURED LIGHT SYSTEMS AND METHODS

(71) Applicants: Raymond Kirk Price, Redmond, WA (US); Denis Demandolx, Bellevue, WA (US); Michael Bleyer, Seattle, WA (US); Ravi Kiran Nalla, San Jose, CA (US); Jian Zhao, Kenmore, WA (US)

(72) Inventors: Raymond Kirk Price, Redmond, WA (US); Denis Demandolx, Bellevue, WA (US); Michael Bleyer, Seattle, WA (US); Ravi Kiran Nalla, San Jose, CA (US); Jian Zhao, Kenmore, WA (US)

(21) Appl. No.: 15/174,712

(22) Filed: Jun. 6, 2016

(51) Int. Cl. H04N 13/02; G02B 27/42; G02B 5/20

(52) U.S. Cl. CPC H04N 13/0253; H04N 13/0296; G02B 5/208; G02B 27/425; H04N 2213/001

(57) ABSTRACT

Structured light systems for three dimensional imaging are provided with a pulsed light source, an imaging sensor and an infrared band-pass filter to selectively pass filtered light to the imaging sensor, as well as a global shutter to control exposure of the imaging sensor to light.

### CROSS-REFERENCE TO RELATED APPLICATIONS

N/A

### BACKGROUND

### Background and Relevant Art

Three-dimensional (3D) imaging systems are configured to identify and map a target based on light that is reflected from the target. Many of these imaging systems are configured with a light source that emits light towards the target and an imaging sensor that receives the light after it is reflected back from the target.

Some imaging systems (i.e., time-of-flight imaging systems) are capable of identifying the distances and positions of objects within a target environment at any given time by measuring the elapsed time between the emission of light from the light source and the reception of the light that is reflected off the objects.

Other imaging systems (e.g., structured light systems) measure the distortion or displacement of light patterns to measure the shapes, surfaces and distances of the target objects. For instance, light may be emitted as a structured pattern, such as a grid pattern, dot pattern, line pattern, etc., towards the target environment. Then, the imaging sensor receives light that is reflected back from the target objects which is also patterned and which is correlated against the known initial pattern to calculate the distances, shapes, and positions of the objects in the target environment.

However, contamination of ambient light in the reflected light/images can degrade the 3D imaging quality. For example, objects that are far away can reflect light at a much lower intensity than close objects. Additionally, brightly illuminated environments, such as outdoor environments during daylight, can also introduce noise through ambient light.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

The disclosed embodiments include devices, systems, and methods for facilitating structured light three-dimensional imaging. Some of the embodiments are operable to reduce energy consumed by structured light three-dimensional imaging systems and/or to improve signal to noise ratios of structured light three-dimensional imaging systems.

In some embodiments, an optical imaging system for three-dimensional imaging includes a laser diode, an imaging sensor, a pulse-shutter coordination device and a band-pass filter. The laser diode is configured to emit a pulse of output light in a first wavelength range. The imaging sensor has a plurality of pixels and a global shutter to selectively allow the plurality of pixels to be exposed to light. The pulse-shutter coordination device is configured to coordinate the pulse of output light from the laser diode within a predetermined pulse time and the exposure of the plurality of pixels to light within a pulse exposure time. The band-pass filter is positioned at a receiving end of the imaging sensor. The band-pass filter is configured to pass light having a second wavelength range to the imaging sensor. The first wavelength range and second wavelength range at least partially overlap.

Disclosed embodiments also include methods for operating structured light three-dimensional imaging systems. These methods include operating a laser diode to emit one or more pulses of output light from the laser diode within a first wavelength range and filtering received incoming light that includes a reflected portion of the output light. Some of the disclosed methods also include filtering the incoming light through a band-pass filter and exposing a plurality of pixels of an imaging sensor to the filtered light for a duration of at least the predetermined pulse time and shuttering the plurality of pixels to at least partially prevent detection of ambient light received at the imaging sensor between the pulses of the one or more pulses.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments that are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that these drawings depict only typical embodiments and are not therefore to be considered to be limiting in scope, embodiments will be described and explained with additional specificity and detail through the use of the accompanying drawings in which:

FIG. 1 is a schematic representation of an embodiment of a three-dimensional imaging system imaging an object;

FIG. 2 is a schematic representation of the embodiment of a three-dimensional imaging system of FIG. 1;

FIG. 3 is a side view of an embodiment of a structured light source emitting a structured light pattern;

FIG. 4 is a chart comparing an embodiment of pulsed structured light emission to continuous wave emission;

FIG. 5 is a chart comparing an embodiment of an imaging sensor exposure time for pulsed structured light emission to an embodiment of photo receptor exposure time for continuous wave emission;

FIG. 6 is a graph comparing ambient light effects on total light received at an imaging sensor;

FIG. 7 is a side view of an embodiment of a bandpass filter positioned to filter light received by an imaging sensor;

FIG. 8 is a chart schematically illustrating the effect of the bandpass filter of FIG. 7; and

FIG. 9 is a flowchart depicting an embodiment of a method of three-dimensional imaging.

### DETAILED DESCRIPTION

Disclosed embodiments include improved imaging systems, as well as devices, systems, and methods for improving efficiency and signal-to-noise ratios in three-dimensional (3D) imaging.

With regard to the following disclosure, it will be appreciated that in the development of the disclosed embodiment(s), as in any engineering or design project, numerous embodiment-specific decisions will be made to achieve the developers' specific goals, such as compliance with system-related and business-related constraints, which may vary from one embodiment to another. It will further be appreciated that such a development effort might be complex and time consuming, but would nevertheless be a routine undertaking of design, fabrication, and manufacture for those of ordinary skill having the benefit of this disclosure.

The accuracy by which a target and/or an environment may be imaged with a 3D imaging system may be at least partially related to ratio of reflected light (light emitted from the imaging system and reflected back to the imaging system) and ambient light captured by imaging system. The reflected light captured may be increased by increasing the intensity of the emitted light. The ambient light captured may be limited by reducing the exposure time of the imaging system and by filtering the spectrum of the light detected by the imaging system.

Some of the disclosed embodiments include imaging systems that are configured with a pulsed light source that emits an output light at higher intensity than conventional imaging systems in non-continuous intervals. In some disclosed embodiments, an imaging system correlates a global shutter of the imaging system to the emission of the output light, such that an imaging sensor of the imaging system collects light during emission from the light source. In some embodiments, an imaging system filters incoming light with a bandpass filter to pass light in the emission wavelengths and block remaining light in the spectrum.

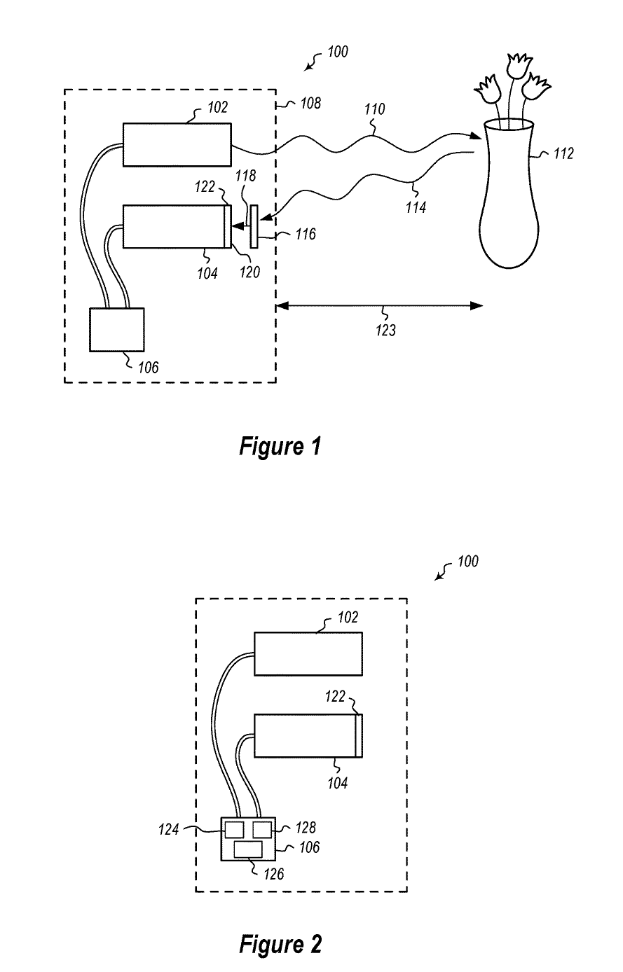

FIG. 1 illustrates a schematic representation of one embodiment of a 3D imaging system 100 that includes a light source 102, an imaging sensor 104, and a pulse-shutter coordination device 106. In some embodiments, two or more components of the 3D imaging system 100 are contained within a single housing 108. For example, FIG. 1 depicts the light source 102, imaging sensor 104, and pulse-shutter coordination device 106 incorporated on a single support frame (i.e., a single board) and/or in a single housing 108.

In other embodiments, one or more components of the 3D imaging system 100 are located separate of the housing 108 or otherwise configured in a distributed system. For example, in some alternative embodiments, the light source 102 and imaging sensor 104 are located within the housing 108 and the pulse-shutter coordination device 106 are located outside the housing 108. In at least one example, the housing 108 is a handheld device containing the light source 102 and the imaging sensor 104, while the pulse-shutter coordination device 106 is contained in a second housing or another device.

The housing 108 may be a handheld portable housing and/or a housing mounted at stationary or fixed location. In some instances, the housing 108 is attached to or integrated into the housing for a vehicle, a robotic device, a handheld device, a portable device, (e.g., a laptop), a wearable device (e.g., a head-mounted device), or another device. The housing 108 may further contain other elements, such as a power source, a communication device, a storage device, and other components.

The light source 102 is configured to emit an output light 110. In some embodiments, the light source 102 is a laser source. For example, the light source 102 may include one or more laser diodes that are attached to a power source and controller and that are thereby configured to produce the output light 110. In some embodiments, the light source 102 may include a plurality of laser sources, such as a plurality of laser diodes on a single die or a plurality of independent laser sources. The plurality of laser sources may each provide output light that is equivalent. In other embodiments, the laser sources may provide output light of different intensities and/or wavelengths.

In some embodiments, the output light 110 may have a first wavelength range. For example, the output light 110 may be emitted from the light source 102 with a spectral width in a first wavelength range less than 100 nanometers (nm), less than 80 nm, less than 60 nm, less than 40 nm, less than 20 nm, less than 10 nm, less than 5 nm, or any values therebetween. For example, the first wavelength range may be less than 50 nm. In some embodiments, the output light 110 may be at least partially in the infrared portion of the light spectrum (i.e., 800 nm to 1 millimeter). For example, the output light 110 may have a first wavelength range of 800 nm to 900 nm. In other examples, the output light 110 may have a first wavelength range of 850 nm to 900 nm. In yet other example, the output light 110 may have a first wavelength range of 825 nm to 850 nm.

The projected or emitted output light 110 is directed towards a target (such as target 112 or other object) in the environment surrounding the 3D imaging system 100. The imaging sensor 104 observes the displacement of the dots in the scene and is able use the distance between the illuminator and the sensor to triangulate the distance to the object. An incoming light 114 that is received by the imaging system 100 may include at least some of the output light 110 that is reflected off the target 112. The incoming light 114 may also include ambient light from the surrounding environment. As the incoming light 114 approaches the imaging sensor 104, the imaging sensor 104 detects at least some of the incoming light 114.

In some embodiments, a bandpass filter 116 is used to pass a filtered light 118 with a second wavelength range to the imaging sensor 104 by filtering the incoming light 114 in such a way as to block light outside of the second wavelength range. The ambient light may have a broad spectrum from the sun, lamps, electronic displays, and other sources that may be broader than and include the emission spectrum of the light source. The incoming light may be a mix of ambient light and the reflected output light. For example, the bandpass filter 116 may pass light in a second wavelength range less than 100 nm, less than 80 nm, less than 60 nm, less than 40 nm, less than 20 nm, less than 10 nm, less than 5 nm, or any values therebetween, while filtering/blocking out other spectra of the incoming light 114. In some instances, the second wavelength range of light that is allowed to pass to the imaging sensor 104 is less than 50 nm.

In some instances, the first wavelength range and the second wavelength range at least partially overlap. By way of example, the first wavelength range may have a width greater than a width of the second wavelength range. Even more particularly, the first wavelength range may be 750 nm to 850 nm, and the second wavelength range may be 800 nm to 875 nm. In other embodiments, the first wavelength range may have a width less than a width of the second wavelength range. For example, the first wavelength range may be 750 nm to 800 nm, and the second wavelength range may be 750 nm to 770 nm. In yet other embodiments, the first wavelength range may have a width equal to a width of the second wavelength range. For example, the first wavelength range may be 750 nm to 800 nm, and the second wavelength range may be 770 nm to 820 nm. In at least one embodiment, the first wavelength range may be the same as the second wavelength range. For example, the first wavelength range may be 750 nm to 800 nm, and the second wavelength range may be 750 nm to 800 nm.

The bandpass filter 116 is configured to pass the filtered light 118 to a receiving end 120 of the imaging sensor 104. In some instances, the bandpass filter 116 is positioned directly at the receiving end of the imaging sensor 104, such as directly adjacent to the receiving end 120 of the imaging sensor 104. In other embodiments, one or more optical elements (e.g., lenses, filters, capillaries, etc.) are interposed between the bandpass filter 116 and the receiving end 120 of the imaging sensor 104.

The imaging sensor 104 is configured with a plurality of pixels to detect and image a light pattern from the incoming light 114. In some embodiments, the imaging sensor 104 includes a charge-coupled device (CCD). In other embodiments, the imaging sensor 104 includes a complimentary metal-oxide semiconductor sensor array (CMOS).

The imaging sensor 104 is also configured with a global shutter 122 that exposes (or conversely, shutters) all of the pixels of the imaging sensor 104 simultaneously.

The detected/imaged light pattern formed from the incoming light 114 (particularly the light that is reflected from the target 112) allows the 3D imaging system 100 to measure the distance 123 to the target 112. Increasing the proportion of the incoming light 114 that is directly attributed to the reflected output light 110 relative to the ambient light will increase the maximum range, accuracy and reliability of measurements of the 3D imaging system 100.

In some embodiments, the emission of the output light 110 from the light source 102 and the exposure of the imaging sensor 104 (via the global shutter 122) is at least partially controlled by the pulse-shutter coordination device 106 shown in FIG. 2.

As shown, the pulse-shutter coordination device 106 is linked (with one or more data communication channels) to the light source 102 and the imaging sensor 104. These data communication channels may include physical communication channels (i.e., using wires, cables, fiber optics, circuity within a printed circuit board, etc.) and/or wireless communication channels (i.e., Wi-Fi, Bluetooth, etc.).

The pulse-shutter coordination device 106 includes a processor 124 and a data storage device 126 in communication with the processor 124. The processor 124 (which may include one or more processor) is configured to control and coordinate the operation of the light source 102 and the imaging sensor 104. For example, the processor 124 may be configured to communicate one or more instructions to the light source 102 to emit an output light (e.g., output light 110 shown in FIG. 1) at a predetermined intensity for a period of time. In other examples, the processor 124 may be configured to communicate one or more instructions to the light source 102 to emit a modulated output light with a predetermined modulation pattern or amount for a period of time.

In some instances, the processor 124 is further configured to communicate one or more instructions to the imaging sensor 106 to coordinate exposure of the plurality of pixels of the imaging sensor 104. In some embodiments, the processor 124 is also configured to identify/compare one or more conditions of the light source 102 (i.e., intensity, wavelength, state of emission, etc.) to one or more conditions of the imaging sensor 104 (i.e., shutter status, gain, etc.). For example, the processor 124 is operable to identify when the light source 102 is emitting an output light, when the global shutter 122 of the imaging sensor 104 is open and when the plurality of pixels of the imaging sensor 104 are exposed.

The processor 124 also communicates one or more instructions to the light source 102 and/or to the imaging sensor 104 based upon one or more detected conditions of the light source 102 and/or the imaging sensor 104. For example, the pulse-shutter coordination device 106 includes a data storage device 126 that is configured to store computer-executable instructions that, when run by the processor 124, allow the pulse-shutter coordination device 106 to instruct the light source 102 to emit output light and for the imaging sensor 104 to detect incoming light, sometimes simultaneously.

The pulse-shutter coordination device 106 receives data related to light detected by the imaging sensor 104 and compares the data to the known output light patterns to image a target and/or the environment in three dimensions. In some embodiments, the data storage device 126 is also configured to retain at least a portion of the data provided by the imaging sensor 104, including the one or more images of the detected light and/or an ambient light pattern. Alternatively, or additionally, the data storage device 126 stores one or more data values associated with the received light, such as peak intensity, integration time, exposure time and/or other values.

The pulse-shutter coordination device 106 also includes a communication module 128, in some embodiments, to communicate the 3D imaging data from the processor 124 and/or data storage device 126 to one or more other computers and/or storage devices. For example, the communication module 128 may be configured to provide communication to another computing device via a physical data connection, such as wires, cables, fiber optics, circuity within a printed circuit board, or other data conduit; via wireless data communication, such as WiFi, Bluetooth, cellular, or other wireless data protocols; removable media, such as optical media (CDs, DVDs, Blu-Ray discs, etc.), solid-state memory modules (RAM, ROM, EEPROM, etc.); or combinations thereof.

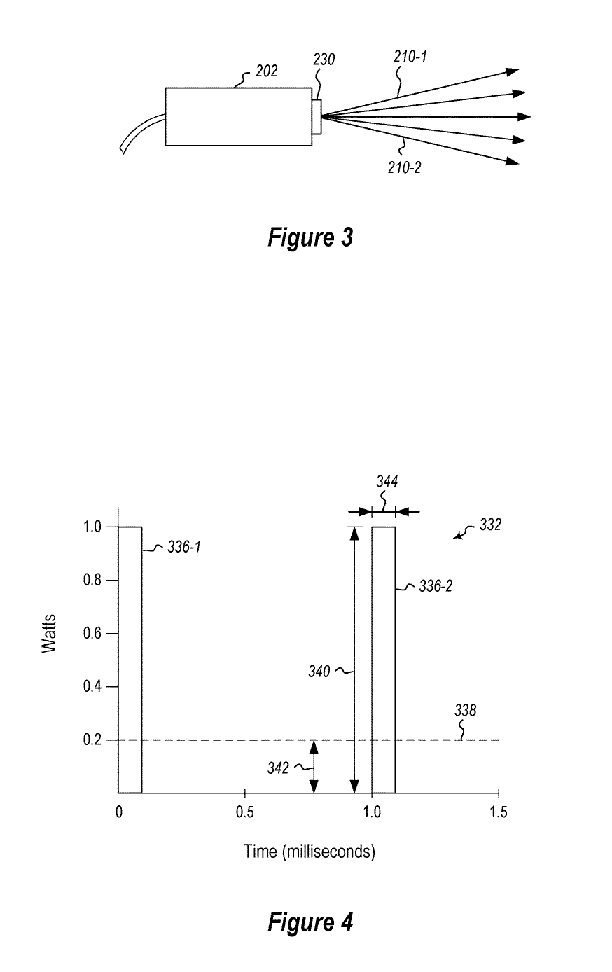

As described herein, the output light of the light source 102 is a structured light provided in a known pattern. FIG. 3 illustrates an embodiment of a light source 202 emitting a structured light pattern including at least a first output light 201-1 and a second output light 201-2. In some embodiments, the light source 102 may include a plurality of emitters to provide at least a first output light 210-1 and a second output light 210-2 in a structured pattern. In other embodiments, the light source 202 includes a diffraction grating 230 to produce a stable light pattern with at least a first output light 210-1 and a second output light 210-2.

In at least one embodiment, the light source 202 is a laser diode that produces a coherent output light. The coherent output light may enter a diffraction grating 230 and diffract through the diffraction grating 230 grating in a dot pattern of output light beams based at least partially upon the wavelength of the coherent output light. For example, the coherent output light may experience nodal interference due to the diffraction grating, producing nodes and anti-nodes of the light pattern. As shown in FIG. 3, a first output light 210-1 may correspond to a first node in the interference pattern of the diffraction grating 230 and a second output light 210-2 might correspond to a second node in the interference pattern of the diffraction grating 230. Conversely, the spacing of the first output light 210-1 and second output light 210-2 may be at least partially related to the positions of anti-nodes in the interference pattern of the diffraction grating.

In other embodiments, a light source may be a light emitting diode (LED) source. However, an LED source does not produce a coherent light source, and therefore may require a plurality of optical elements, such as lenses, gratings, capillaries, or additional elements to produce a light pattern.

FIG. 4 is a graph 332 illustrating a comparison of a series of output light pulses 336-1 and 336-2 to a conventional continuous wave 338 of output light. The graph 332 illustrates an intensity of the output light as a function of time. In this example, the continuous wave 338 has a relatively constant intensity over time. In contrast, the output light pulses 336-1 and 336-2 have a pulse amplitude 340 that is greater than the continuous wave amplitude 342.

In some instance, a light source may be driven at relatively higher amplitudes, for shorter periodic durations, than is conventionally possible with a continuous light output. For example, in some embodiments, the light source may be driven at a pulse amplitude 340 that is greater than 1.0 watts, greater than 1.1 watts, greater than 1.2 watts, greater than 1.3 watts, greater than 1.4 watts, greater than 1.5 watts, greater than 1.75 watts, greater than 2.0 watts, greater than 2.5 watts, or greater than any value therebetween. In some instances, the light source is driven at a pulse amplitude 340 greater than 1.8 watts.

Most light sources have established or official continuous wave rating (i.e., an amplitude at which the light source may be driven without degradation of the light emitting element). In some instances, the light source of the disclosed embodiments are driven in pulses at a pulse amplitudes 340 that are greater than their continuous wave ratings. For example, the light source may be driven at a pulse amplitude 340 in a multiple of the continuous wave rating that is greater than 2, greater than 3, greater than 4, greater than 5, greater than 6, greater than 8, or greater than 10 times the continuous wave rating for the light source. In the embodiment depicted in FIG. 4, the pulse amplitude is 5 times greater than the continuous wave rating of the continuous wave 338.

The series of output light pulses (336-1, 336-2) has a pulse duration 344 for each of the output light pulses (i.e., the first output light pulse 336-1, the second output light pulse 336-2, etc.). The pulse duration 344 may be in a range having an upper value, a lower value, or upper and lower values including any of 5 nanoseconds (ns), 10 ns, 50 ns, 100 ns, 250 ns, 500 ns, 1 microsecond (μs), 5 μs, 10 μs, 50 μs, 100 μs, 250 μs, 500 μs, 1 millisecond, or any values therebetween. For example, the pulse duration 344 may be less than 1 millisecond. In other examples, the pulse duration 344 may be in a range of 5 ns to 1 millisecond. In yet other examples, the pulse duration 344 may be in a range of 10 ns to 100 μs. In further examples, the pulse duration 344 may be less than 100 μs. In at least one embodiment, the pulse duration 344 is about 100 μs.

The ratio of the pulse duration 344 to the duration of each frame (i.e., the start of each output light pulse) is the duty cycle of the light source. In some embodiments, the duty cycle may be less than 50%, less than 40%, less than 30%, less than 20%, or less than 10%. For example, the light source may emit the first output light pulse 336-1 for 100 ns, and emit the second output light pulse 336-2 approximately 900 ns after the end of the first output light pulse 336-1. The duty cycle of the output light pulses 336-1, 336-2 shown in FIG. 4 is about 10%.

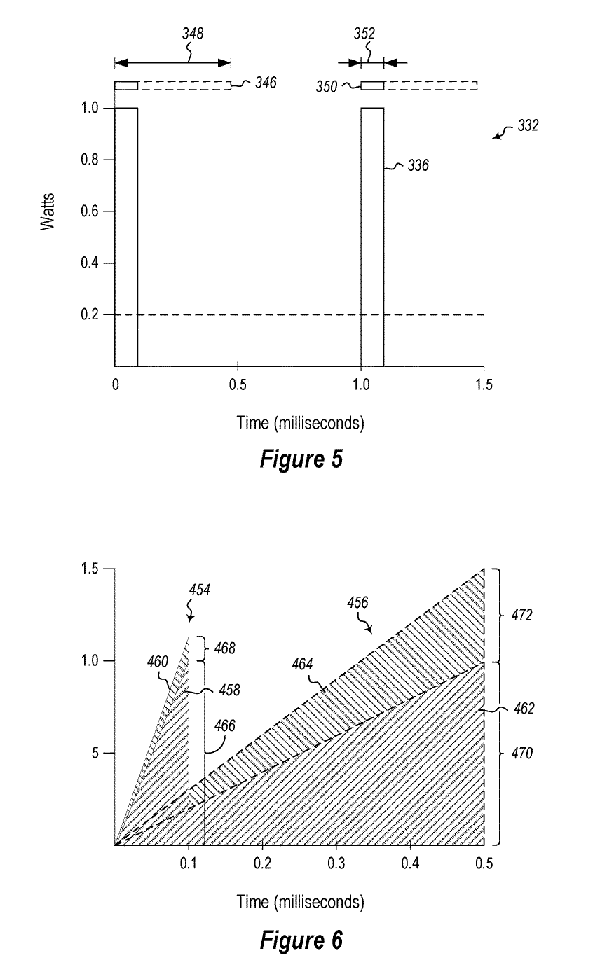

FIG. 5 illustrates the graph 332 of FIG. 4 with exposure times overlaid on the time axis. The exposure of the imaging sensors may be at least partially related to the series of output light pulses 336. The global shutter, as described herein, will open to expose the imaging sensor for a pulse exposure duration 352. A conventional continuous wave imaging system may have a conventional exposure 346 and associated integration time 348 of an imaging sensor that is greater than a pulse duration of an imaging system according to the present disclosure. The pulse exposure duration 352 may overlap the output light pulse 336, as shown in FIG. 5. It will be appreciated that this pulse exposure duration 352 may be significantly shorter than the conventional exposure 346 and integration times 348 required to capture a full frame with conventional systems running continuous wave light sources.

In some embodiments, the pulse exposure duration 352 may be in a range having an upper value, a lower value, or upper and lower values including any of 5 nanoseconds (ns), 10 ns, 50 ns, 100 ns, 250 ns, 500 ns, 1 microsecond (μs), 5 μs, 10 μs, 50 μs, 100 μs, 250 μs, 500 μs, 1 millisecond, or any values therebetween. For example, the pulse exposure duration 352 may be less than 1 millisecond. In other examples, the pulse exposure duration 352 may be in a range of 5 ns to 1 millisecond. In yet other examples, the pulse exposure duration 352 may be in a range of 10 ns to 100 μs. In further examples, the pulse exposure duration 352 may be less than 100 μs. In at least one embodiment, the pulse exposure duration 352 is about 100 μs. In at least one embodiment, the pulse exposure duration 352 may be equal to the duration of the output light pulse 336 and simultaneous with the output light pulse 336, as shown in FIG. 5.

By at least partially correlating the pulse exposure duration 352 with the duration of the output light pulse 336, the imaging systems of the disclosed embodiments are able to expend energy (emitting and detecting light) only during the comparatively short pulses, in contrast to the conventional system integrating for longer durations and emitting a continuous wave irrespective of detection of light.

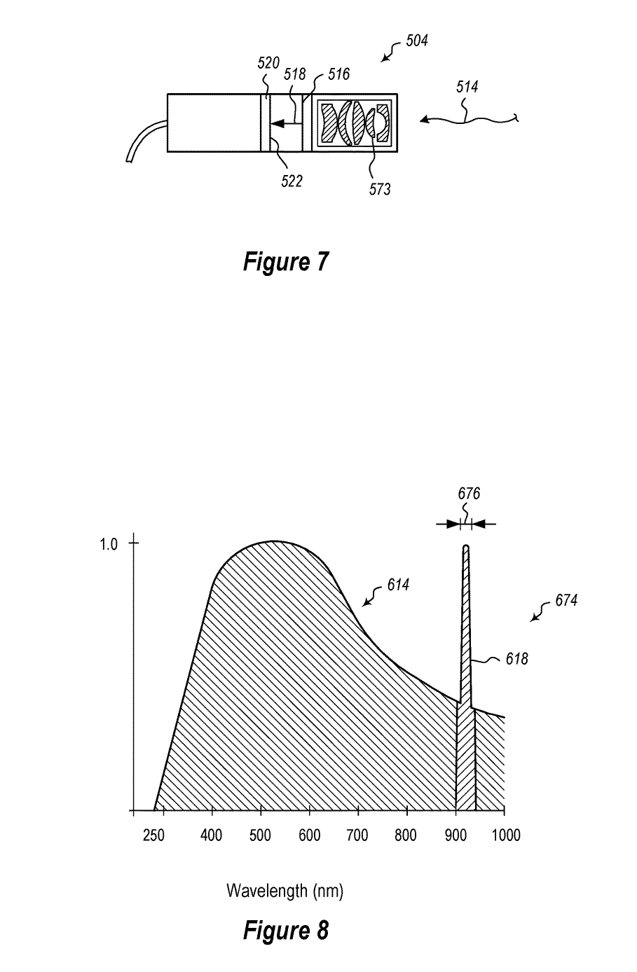

FIG. 6 schematically illustrates an example of the relative portions of the detected light in a conventional 3D imaging system and a pulsed 3D imaging system, according to the present disclosure. The total detected pulsed light 454 is collected and/or integrated over a shorter duration relative to a total detected continuous wave light 456. The total detected pulsed light 454 includes the comparatively higher intensity reflected output pulse light 458 (from the higher intensity output light pulse) relative to the reflected continuous wave light 462. The same amount of reflected output pulse light 458 (normalized to 1.0 in FIG. 6) is received by the imaging sensor in a shorter period of time compared to the lower intensity reflected continuous wave light 462.

The shorter duration (100 μs in the example depicted in FIG. 6) of the total detected pulsed light 454 allows less ambient light 460 to contribute to the total detected pulsed light 454. Comparatively, the longer duration (500 μs in the example depicted in FIG. 6) of the total detected continuous wave light 456 to collect the same amount of reflected continuous wave light 462 allows a greater amount of ambient light 464 during the exposure time.

The ratio of the reflected light to ambient light is higher in the total detected pulsed light 454 than in the total detected continuous wave light 456. For example, the pulse signal 466 to pulse noise 468 ratio is less than the continuous wave signal 470 to continuous wave noise 472, despite the pulse signal 466 and the continuous wave signal 470 being similar. Limiting the exposure duration to collect the same amount of signal limits the introduction of ambient light, and hence noise, in the detected light.

To further limit the detection of ambient light and/or noise at the imaging sensor, a bandpass filter passes a second wavelength range to the imaging sensor and blocks the remainder of the light spectrum. For example, an embodiment of an imaging sensor 504 is illustrated in FIG. 7.

The imaging sensor 504 includes a bandpass filter 516 positioned at a receiving end 520 of the imaging sensor to limit the incoming light 514, which may include both reflected output light and ambient light. The bandpass filter 516 filters the incoming light 514 and passes a filtered light 518 to the plurality of pixels of the imaging sensor 504.

A global shutter 522 controls the exposure of the imaging sensor 504 to the filtered light 518, as previously disclosed. The bandpass filter 516 is also configured to pass filtered light 518 in a second wavelength range of light that is at least partially overlapping with a first wavelength range of the output light. The filtering of the incoming light 514 with the bandpass filter 516 reduces the amount of ambient light that may contribute to the light received at the plurality of pixels of the imaging sensor 504, improving a signal-to-noise ratio.

FIG. 8 is a graph 674 representing an embodiment of a bandpass filter filtering incoming light 614 down to filtered light 618. The filtered light 618 is the portion of the incoming light 614 that is passed to the pixels of the imaging sensor. The spectrum of the incoming light 614 includes ambient light (approximated as sunlight in FIG. 8) that comprises the majority of the spectrum, with a peak within the first wavelength range that corresponds to the output light emitted by the light source. The bandpass filter may transmit or pass the majority of the light within a second wavelength range 676 (i.e., the bandwidth of the bandpass filter) and attenuate light elsewhere in the spectrum to pass the comparatively narrow spectrum of the filtered light 618 to the imaging sensor.

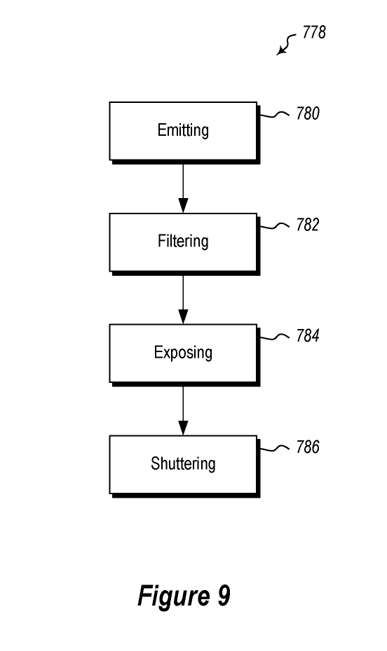

FIG. 9 illustrates an embodiment of a flowchart 778 that includes various acts associated with the disclosed methods for operating a structured light 3D imaging system having a laser diode. The illustrated acts include emitting 780 one or more intermittent pulses of output light from a laser diode within a first wavelength range, wherein the one or more intermittent pulses having a predetermined pulse time. As described herein, the output light may be a coherent light. The first wavelength range may have a width less than 100 nm, less than 80 nm, less than 60 nm, less than 40 nm, less than 20 nm, less than 10 nm, less than 5 nm, or any values therebetween. For example, the first wavelength range may be 700 nm to 800 nm. In other examples, the first wavelength range may be 750 nm to 800 nm. In yet other example, first wavelength range may be 825 nm to 850 nm.

The emitting of the light 780 may also include passing the light through a diffraction grating to produce a patterned output light.

The disclosed acts also include filtering 782 an incoming light. This incoming light will include a reflected portion of the output light that is passed through a band-pass filter. The filtered incoming light is then exposed (act 784) to a plurality of pixels of an imaging sensor for an exposure time having a duration at least the predetermined pulse time and, in some instances, less than 10 ns to 100 μs. After exposing 784 the plurality of pixels to the light for the predetermined exposure time, the system shutters (act 786) the plurality of pixels to at least partially prevent detection of ambient light received at the imaging sensor between the intermittent pulses. In some embodiments, the plurality of pixels may remain shuttered for a shuttering time that is at least 3 times greater than the predetermined pulse time.

The relative amount of time that the shutter is open and the plurality of pixels exposed to light may be related to the emitting of the light 780. In other words, the amount of time that the shutter is open may be related to a duty cycle of the light source. In some embodiments, the duty cycle of the light source may be approximately 50%. In other embodiments, the duty cycle may be less than 50%, less than 40%, less than 30%, less than 20%, or less than 10%.

The disclosed structured light 3D imaging systems may increase signal to noise ratio by limiting the exposure of the imaging sensor to ambient light. In at least one embodiment, a gated pulsed 3D imaging system of the present disclosure may consume less energy than a conventional 3D imaging system with a continuous wave of output light.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An optical imaging system for three-dimensional imaging, the system comprising:
a laser diode that is configured to emit a pulse of output light in a first wavelength range;
an imaging sensor having a plurality of pixels and a global shutter to selectively allow an exposure of light to the plurality of pixels;
a pulse-shutter coordination device configured to coordinate the pulse of output light from the laser diode within a predetermined pulse time and the exposure of the plurality of pixels to light within a pulse exposure time; and
a band-pass filter positioned at a receiving end of the imaging sensor, the band-pass filter configured to pass light having a second wavelength range to the imaging sensor, the first wavelength range and second wavelength range at least partially overlapping.

2. The system of claim 1, wherein the laser diode comprises a coherent light source.

3. The system of claim 1, wherein the first wavelength range has a width of 20 nanometers or less.

4. The system of claim 1, wherein the second wavelength range has a width of 50 nanometers or less.

5. The system of claim 1, wherein the first wavelength range has a width equal to a width of the second wavelength range.

6. The system of claim 1, wherein the imaging sensor is selected from a group consisting of a charge coupled device and a complimentary metal-oxide semiconductor sensor array.

7. The system of claim 1, wherein the laser diode has a continuous wave rating and the laser diode emits the pulse of output light at greater than 1.5 times the continuous wave rating.

8. The system of claim 1, further comprising a diffraction grating to direct the output light in a predetermined structure.

9. The system of claim 1, wherein the predetermined pulse time is less than 100 microseconds.

10. The system of claim 1, wherein the laser diode comprises a plurality of light diodes.

11. The system of claim 10, wherein the plurality of laser diodes generate light with at least one of different pulses or different light wavelengths.

12. A method for operating a structured light three-dimensional imaging system that includes a laser diode, the method comprising:
emitting one or more pulses of output light from a laser diode within a first wavelength range, each pulse of the one or more pulses having a predetermined pulse time;
filtering an incoming light including a reflected portion of the output light through a band-pass filter with a band-pass defining a second wavelength range;
exposing a plurality of pixels of an imaging sensor to the filtered light for a duration of at least the predetermined pulse time; and
shuttering the plurality of pixels to at least partially prevent detection of ambient light received at the imaging sensor between the pulses.

13. The method of claim 12, wherein the first wavelength range has a width of 20 nanometers or less.

14. The method of claim 12, wherein the second wavelength range has a width of 50 nanometers or less.

15. The method of claim 12, wherein the second wavelength range encompasses the first wavelength range and additional wavelengths greater than the first wavelength range.

16. The method of claim 12, further comprising structuring the output light with a diffraction element.

17. The method of claim 12, wherein emitting the output light and exposing the plurality of pixels are simultaneous.

18. The method of claim 12, wherein the output light is infrared light.

19. The method of claim 12, wherein a duty cycle of the laser diode is less than 50%.

20. A structured light imaging system, the system comprising:
a structured light laser diode, the laser diode configured to emit a pulse of structured output light in a first wavelength range with a first bandwidth of less than 20 nanometers through a diffraction grating, the pulse having a peak intensity of 1 watt or greater;
an imaging sensor having a plurality of pixels and a global shutter to selectively allow an exposure of an input light to the plurality of pixels;
a pulse-shutter coordination device configured to temporally coordinate the pulse of structured output light from the structured light laser diode and exposure of the plurality of pixels to incoming light within a pulse time; and
a band-pass filter which filters light at a second bandwidth of less than 50 nm and encompassing the first bandwidth, the band-pass filter positioned at a light receiving end of the imaging sensor.
